(19) United States
(12) Patent Application Publication
(10) Pub. No.: US 2022/0326359 A1
(43) Pub. Date: Oct. 13, 2022

(54) MEASUREMENT AND COMPENSATION FOR PHASE ERRORS IN TIME-OF-FLIGHT-CAMERAS

(71) Applicant: BASLER AG, Ahrensburg (DE)

(72) Inventor: Timon Ehrlich, Ahrensburg (DE)

(73) Assignee: BASLER AG, Ahrensburg (DE)

(21) Appl. No.: 17/633,966

(22) PCT Filed: Aug. 11, 2020
(86) PCT No.: PCT/EP2020/072469

§ 371 Date: Feb. 9, 2022

(30) Foreign Application Priority Data
Aug. 12, 2019 (DE) 10 2019 121 686.9

(51) Int. Cl. G01S 7/4865; G01S 17/26; G01S 17/89; G01S 7/497

(52) U.S. Cl. CPC G01S 7/4865; G01S 17/26; G01S 17/89; G01S 7/497

(57) ABSTRACT

A time-of-flight, ToF, camera for measuring distance information for objects of a scene includes a light source for emitting modulated light signals for illuminating the objects, an image sensor for capturing reflected light signals, and shutters for opening and closing the exposure of the image sensor. A pulse generator generates first pulses for switching the light source and second pulses for switching the shutters. A first driver amplifies the first pulses and outputs the same to the light source, and a second driver amplifies the second pulses and outputs the same to the shutters. A time measurement unit measures the propagation time of the pulses through the drivers and/or the pulse duration of the pulses output from the drivers. A processing unit generates a distance measurement image based on the captured reflected light signals to reduce the influence of phase errors on the distance measurement image.

### CROSS-REFERENCE TO FOREIGN PRIORITY APPLICATION

The present application claims the benefit under 35 U.S.C. §§ 119(b), 119(e), 120, and/or 365(c) of PCT/EP2020/072469 filed Aug. 11, 2020, which claims priority to German Application No. DE 10 2019 121 686.9 filged Aug. 12, 2019.

### FIELD OF THE INVENTION

The invention relates to a time-of-flight, ToF, camera for measuring distance information for objects in a scene and a corresponding ToF method. In particular, the invention relates to the measurement and compensation of phase errors in a ToF camera or a ToF method.

### BACKGROUND OF THE INVENTION

Light propagates at a speed approaching 300,000 kilometers per second. By measuring the propagation time of light between two points very precisely, it is possible to calculate the distance between them. This principle forms the basis of the distance measurement techniques used in so-called time-of-flight, ToF, cameras. A ToF camera includes a light source and an image sensor. The light source emits a modulated light signal that reflects off objects in the scene, and the ToF camera measures the time between the emission and the arrival of the reflected light signal at the image sensor. For each pixel (or for a subset of the pixels) of the image sensor, a distance of the light reflecting objects to the ToF camera calculated from the measured propagation time is then output.

In addition to distance values, some ToF cameras also generate color or brightness values (and possibly other values, such as confidence values or the like), which can then also be output. ToF cameras, which are often also referred to as “active cameras” because they are equipped with their own light source, are used in a wide range of applications, e.g., in robotics, industrial automation, logistics and medicine, as well as in various areas of the “smart factory.”

The accuracy of the ToF method depends on how precise the time measurement is. Since the delay time of the light is only about 3.3 ns per meter, the resolution of the time measurement must be correspondingly high. In the so-called pulse modulation, the light source of the ToF camera emits a light pulse at a point in time t₀ and simultaneously starts a high-precision time measurement. If the light reflected from an object in the scene then arrives at the camera at a time t₁ the distance to the object can be determined directly from the measured time of flight. t₁−t₀ as d=c/2·(t₁−t₀) where c indicates the speed of light. Alternatively, however, a sinusoidal modulation of the light signal can be used, in which case the distance values are derived from the phase shift between the outgoing and incoming light signals. This method is also referred to in the literature as the continuous modulation, or continuous wave (CW), method.

In practice, both pulse modulation and CW methods as well as mixed forms of both are used:

For example, in a known process, a rectangular light pulse of duration tₚ is emitted and at the same time a first electronic shutter is opened for the duration of the light pulse. The reflected light arriving in the ToF camera during this time is stored as a first electrical charge S₁. Now the first shutter is closed and a second shutter is—at the time the light source is switched off—also opened for the duration tₚ. The reflected light arriving in the ToF camera during this time is stored as a second electrical charge S₂. Since the light pulse is very short, this process is repeated several thousand times until the set exposure time is over. Subsequently, the integrated electrical charges S₁ and S₂ are read out.

As a result, two partial measurement images are obtained, which show for each pixel the integrated electric charge S₁ respectively S₂ for each pixel. In the S₁ partial measurement image, the near objects of the scene are brighter, because with increasing distance less and less reflected light reaches the ToF camera as long as the first shutter is still open. With the S₂ measurement, on the other hand, it is exactly the opposite. Here, close objects are dark because the second shutter only opens when the light has already been traveling for a while. The ratio of the integrated electrical charges S₁ and S₂ thus changes depending on the distance the emitted and reflected light has traveled. Thus, the distance to the object can be calculated for each pixel as

$$d = \frac{c}{2} \cdot {t}_{p} \cdot \frac{{S}_{2}}{{S}_{1} + {S}_{2}} ) \qquad ( 1 )$$

where c again indicates the speed of light. In this method, the distance measurement is thus based on the measurement of the phase position of reflected rectangular pulses.

The smallest measurable distance is measured when all charge is stored during the early shutter time as S₁ and no charge is stored during the delayed shutter time as S₂, i.e., S₂=0. Equation (1) then gives d=0. In contrast, the largest measurable distance is measured just when all charge is stored as S₂ and no charge is stored as S₁, i.e. S₁=0. In this case, equation (1) gives d=c/2·tₚ. From this it can also be seen that the light pulse width determines the maximum measurable distance in this method. If tₚ is, for example, 47 nanoseconds, distances from 0 to 7 meters can be measured.

If distances are to be measured in an illuminated scene, the background light leads to a distortion of the measurement results. To avoid this, a third exposure without a light pulse can be performed by the ToF camera, so that only the background light of the scene is stored as a third electrical charge S₃ (third partial measurement image). The integrated electric charge S₃ can then be subtracted from the integrated electric charges S₁ and S₂, whereby the following formula for the distance measurement results

$$d = \frac{c}{2} \cdot {t}_{p} \cdot \frac{{S}_{2} - {S}_{3}}{{S}_{1} + {S}_{2} - 2 \cdot {S}_{3}} . \qquad ( 2 )$$

The principle that for the measurement of distances in an illuminated scene three different signals S₁, S₂, and S₃ are necessary is also used in an alternative approach in which three shutters are opened and closed 120° out of phase with respect to a period of 360°. Three partial measurement images are then also obtained, which are sufficient to ensure a distance measurement in the presence of three unknowns, distance to the object, reflectivity of the object, and ambient light. The advantage of this approach is that the illumination of the ToF camera is active in each of the three phase-shifted opening times of the shutters, so that light can also be emitted from the ToF camera during the opening of the third shutter, during which the background light was previously measured.

In practice, the light source and the shutters of a ToF camera are switched using pulses applied to these components. The pulses are generated, for example, by a field programmable gate array (FPGA) device with logic standard signals. To enable the switching signals with their logic standard levels to switch the light source or the shutters of the ToF camera, the logic standard levels are each passed to a driver structure for amplification, the outputs of which are then applied to the light source or the shutters.

Due to different propagation times of the switching signals through the driver structures, phase errors occur as a matter of principle, which can falsify the distance measurement. These errors are usually measured once during the production of a ToF camera and correction parameters are stored in the camera, which can be used to calculate corrected distance measurement values that better match the real distances. However, the phase errors are generally not temperature stable, i.e., they are dependent on thermal influences, and aging of the electronic components can also change the signal propagation times and the pulse durations of the pulses applied to the light source or the shutters. This is problematic because, for example, the temperature in a ToF camera depends on operating parameters of the ToF camera, in particular the exposure time, as well as on external influences such as the ambient temperature.

In view of these problems, it would therefore be desirable to provide for a ToF camera and a ToF method in which the influence on the distance measurements of phase errors, which may result from changes in temperature and from aging of the electronic components, among other factors, can be reduced as much as possible.

### SUMMARY OF THE INVENTION

It is an object of the invention to provide a time-of-flight, ToF, camera that makes it possible to reduce the influence on the distance measurements of phase errors that can arise, among other factors, due to changes in temperature and aging phenomena of the electronic components. Furthermore, it is an object of the invention to provide a corresponding ToF method.

According to a first aspect of the invention, there is provided a time-of-flight, ToF, camera for measuring distance information for objects of a scene, the ToF camera comprising:
a light source for emitting modulated light signals for illuminating the objects;
an image sensor for capturing light signals reflected from the objects;
shutters for opening and closing the exposure of the image sensor;
a pulse generator for generating first pulses for switching the light source and second pulses for switching the shutters;
a first driver for amplifying the first pulses and outputting them to the light source, and a second driver for amplifying the second pulses and outputting them to the shutters;
a time measurement unit for measuring the propagation time of the pulses through the drivers and/or the pulse duration of the pulses output from the drivers; and
a processing unit for generating a distance measurement image based on the captured reflected light signals, wherein the processing unit is adapted to use the measured propagation time of the pulses and/or the measured pulse duration to reduce the influence of phase errors on the distance measurement image.

The invention is based on the inventor's realization that the drivers used in a ToF camera for the amplification of the pulses for switching the light source and the shutters generally have delay times of different lengths, which are also dependent on thermal influences and aging of the electronic components. This leads to changing phase errors that are difficult to address “statically” when manufacturing a ToF camera. Therefore, it is proposed to measure the propagation time of the pulses through the drivers and/or the pulse duration of the pulses output from the drivers with a time measurement unit and to use the measured propagation time of the pulses and/or the measured pulse duration to generate the distance measurement image with a reduced phase error.

The light source advantageously emits the modulated light into the field of view of the ToF camera. For example, LEDs (light emitting diodes) or LDs (laser diodes) can be used. In many applications, infrared light is used as illumination. This has the advantage that it is visually inconspicuous and, in particular, has little or no influence on color or brightness values to be additionally recorded.

The light signals emitted by the light source can preferably have a rectangular modulation and three shutters can be provided, each of which is opened and closed 120° out of phase with respect to a period of 360°. The processing unit can then generate the distance measurement image from three partial measurement images. This is sufficient to ensure a distance measurement in the presence of three unknowns, distance to the object, reflectivity of the object, and ambient light.

The pulse generator is preferably a field programmable gate array (FPGA) device that generates the pulses with logic standard signals. In this case, the drivers amplify the logic standard levels so that the switching signals can switch the light source or the shutters of the ToF camera with their logic standard levels.

According to an advantageous embodiment, the time measurement unit is a time-to-digital converter. Such time-to-digital converters are essentially very fast stopwatches that can be used to measure signal propagation times, for example, in two-digit picosecond resolution. An example of a commercially available time-to-digital converter is the TDC7201 from Texas Instruments with a temporal resolution of 55 ps. This device uses an internal, self-calibrated time base that compensates for variations over time as well as with temperature, enabling a highly accurate time measurement. A time-to-digital converter is, therefore, advantageously suited to provide the temporal accuracy required when drivers measure signal propagation times. In addition, these devices are compact enough to be integrated in a ToF camera.

According to an advantageous embodiment, the pulse generator is adapted to generate and output a start pulse to the time measurement unit, and the time measurement unit is adapted to start the measurement of the propagation time of the pulses through the drivers and/or the pulse duration of the pulses output from the drivers upon receipt of the start pulse. By the fact that the start pulse for the measurement of the propagation time of the pulses through the drivers and/or the pulse duration of the pulses output from the drivers is also generated by the pulse generator, the start of the measurement can be synchronized in a simple way with the generation of the first and second pulses.

According to an advantageous embodiment, the ToF camera further comprises a memory unit for storing the temporal positions of the pulses generated by the pulse generator relative to the temporal position of the start pulse. In this way, the temporal relationships between the start pulse and the first and second pulses can be stored in the ToF camera and used in further processing to reduce the influence of phase errors on the distance measurement image.

According to an advantageous embodiment, the time measurement unit is adapted to receive the pulses output from the drivers and to measure the propagation time of the pulses through the drivers and/or the pulse duration of the pulses output from the drivers based on the received pulses. Preferably, a first input of the time measurement unit is operatively coupled to an output of the first driver and a second input of the time measurement unit is operatively coupled to an output of the second driver.

According to an advantageous embodiment, the pulses output from the drivers have a leading edge, and the time measurement unit is adapted to measure the propagation time of the pulses through the drivers based on the temporal position of the leading edge. The leading edge of the pulses output from the drivers can preferably be detected in a simple manner and with high temporal accuracy and thus provides a suitable reference point for measuring the propagation time of the pulses through the drivers.

According to an advantageous embodiment, the pulses output from the drivers further have a trailing edge and the time measurement unit is adapted to measure the pulse duration of the pulses output from the drivers based on the temporal position of the leading edge and the temporal position of the trailing edge. The trailing edge of the pulses output from the drivers can preferably also be detected in a simple manner and with high temporal accuracy. This reference point and the temporal position of the leading edge can then be used to measure the pulse duration of the pulses output from the drivers.

According to an advantageous embodiment, the pulses output from the drivers have a leading rising edge and a trailing falling edge. With the help of this design, it is possible to determine an exact time for the pulses.

According to an advantageous embodiment, the processing unit is adapted, based on the measured propagation time of the pulses and/or the measured pulse duration, to control the pulse generator to adjust the temporal positions of the pulses in order to reduce the phase errors in generating the distance measurement image. In this way, signal propagation times of different length in the drivers and/or changes in pulse durations can be compensated for by the drivers immediately when the pulses are generated by the pulse generator. The pulses output from the drivers then preferably have as correct a phase relationship as possible, so that the distance measurement is only distorted to a lesser extent or not at all by phase errors.

According to an advantageous embodiment, the processing unit is adapted to perform a correction of the distance measurement values based on the measured propagation time of the pulses and/or the measured pulse duration when generating the distance measurement image in order to reduce errors caused by the phase errors in the distance measurement image. For this purpose, for example, the complete distance measurement image can first be calculated based on the captured reflected light signals. Then, the measured delay time can be used to determine a distance correction value using the speed of light, which corresponds to half the distance that the light signal travels during the delay time. The distance correction value can then be used to correct the distance measurement values in the distance measurement image, for example by adding together the respective distance measurement value and the distance correction value.

According to another aspect of the invention, there is provided a time-of-flight, ToF, method for measuring distance information for objects of a scene, the ToF method comprising:
emitting modulated light signals for illuminating the objects, with a light source;
capturing light signals reflected from the objects, with an image sensor;
opening and closing the exposure of the image sensor, with shutters;
generating first pulses for switching the light source and second pulses for switching the shutters, with a pulse generator;
amplifying the first pulses and outputting them to the light source, with a first driver, and amplifying the second pulses and outputting them to the shutters, with a second driver;
measuring the propagation time of the pulses through the drivers and/or the pulse duration of the pulses output from the drivers, with a time measurement unit; and
generating a distance measurement image based on the captured reflected light signals, using the measured propagation time of the pulses and/or the measured pulse duration to reduce the influence of phase errors on the distance measurement image.

It is understood that the ToF camera according to the present disclosure and the ToF method according to the present disclosure have similar and/or identical preferred embodiments, particularly as defined in the dependent claims.

It is understood that a preferred embodiment of the invention may also be any combination of the dependent claims with the corresponding independent claim.

### BRIEF DESCRIPTION OF THE DRAWINGS

Preferred embodiments of the invention are described in more detail below with reference to the accompanying Figures, wherein:

FIG. 1 schematically and exemplarily shows the structure of a ToF camera according to the invention, and

FIG. 2 schematically and exemplarily shows a flow diagram of a ToF method according to the invention.

### DETAILED DESCRIPTION OF THE EMBODIMENTS

In the Figures, identical or corresponding elements or units are each given identical or corresponding reference signs. If an element or unit has already been described in connection with a Figure, a detailed description may be omitted in connection with another Figure.

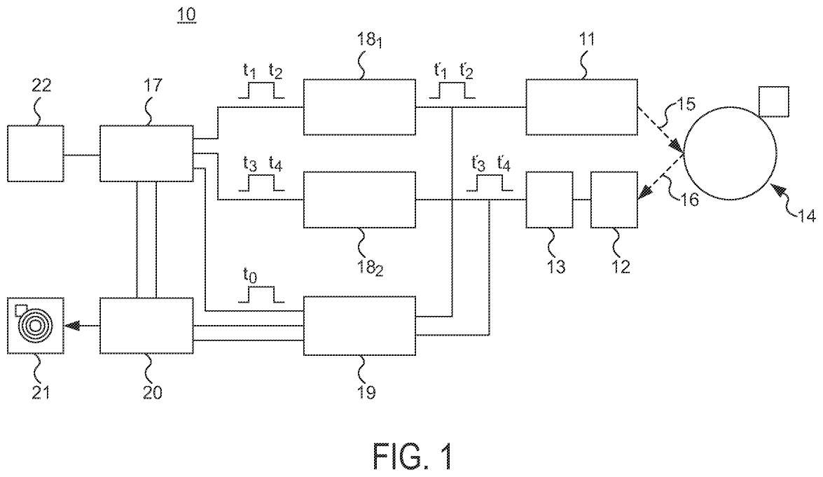

FIG. 1 shows schematically and exemplarily the structure of a ToF camera 10 according to the invention for measuring distance information for objects 14 of a scene, such as can be used in robotics, industrial automation, logistics and medicine, or in various areas of the “smart factory.” The ToF camera 10 includes a light source 11 for emitting modulated light signals 15 for illuminating the objects 14, an image sensor 12 for capturing light signals 16 reflected from the objects 14, and a processing unit 20 for generating a distance measurement image 21 based on the captured reflected light signals 16.

The light source 11 advantageously emits the light into the field of view of the ToF camera 10. For example, LEDs (light emitting diodes) or LDs (laser diodes) can be used. In this embodiment, infrared light is used as illumination. This has the advantage that it is visually inconspicuous and, in particular, has little or no effect on color or brightness values to be additionally recorded.

The ToF camera 10 further comprises shutters 13 for opening and closing the exposure of the image sensor 12, a pulse generator 17 for generating first pulses for switching the light source 11 and second pulses for switching the shutters 13, and a first driver 18₁ for amplifying the first pulses and outputting them to the light source 11, and a second driver 18₂ for amplifying the second pulses and outputting them to the shutters 13. The pulse generator 17 here is an FPGA that generates the pulses with logic standard signals. The drivers 18₁ and 18₂ amplify the logic standard levels so that the switching signals with their logic standard levels can switch the light source 11 and the shutters 13 of the ToF camera 10, respectively.

In this embodiment, the light signals emitted by the light source 11 have a rectangular modulation and three shutters (not shown individually in the Figure) are provided, each of which is opened and closed 120° out of phase with respect to a period of 360°. The processing unit 20 then generates the distance measurement image 21 from three partial measurement images. This is sufficient to ensure a distance measurement in the presence of three unknowns, distance to the object, reflectivity of the object, and ambient light.

As described above, the problem is that the drivers 18₁ and 18₂ used in the ToF camera 10 for the amplification of the pulses for switching the light source 11 and the shutters 13 generally have delay times of different lengths, which are also dependent on thermal effects and aging of the electronic components. This leads to changing phase errors that are difficult to address “statically” in the manufacturing of the ToF camera 10. Therefore, the ToF camera 10 according to the invention further comprises a time measurement unit 19 for measuring the propagation time of the pulses through the drivers 18₁ and 18₂ and/or the pulse duration of the pulses output from the drivers 18₁ and 18₂, and the processing unit 20 is adapted to use the measured propagation time of the pulses and/or the measured pulse duration to generate the distance measurement image 21 with a reduced phase error.

In this embodiment, the time measurement unit 19 is a time-to-digital converter, for example, the TDC7201 from Texas Instruments, which can be used to measure signal propagation times in two-digit picosecond resolution. The pulse generator 17 is adapted to output a start pulse to the time measurement unit 19, and the time measurement unit 19 is adapted to start measuring the propagation time of the pulses through the drivers 18₁ and 18₂ and/or the pulse duration of the pulses output from the drivers 18₁ and 18₂ upon receipt of the start pulse.

The ToF camera 10 further comprises a memory unit 22 for storing the temporal positions t₁, t₂, t₃, and t₄ of the pulses generated by the pulse generator 17 relative to the temporal position t₀ of the start pulse.

The time measurement unit 19 is adapted to receive the pulses output from the drivers 18₁ and 18₂ and measure the propagation time of the pulses through the drivers 18₁ and 18₂ and/or the pulse duration of the pulses output from the drivers 18₁ and 18₂ based on the received pulses. In this embodiment, a first input of the time measurement unit 19 is operatively coupled to an output of the first driver 18₁ and a second input of the time measurement unit 19 is operatively coupled to an output of the second driver 18₂.

The pulses output from the drivers 18₁ and 18₂ have a leading edge, and the time measurement unit 19 is adapted to measure the propagation time of the pulses through the drivers 18₁ and 18₂ based on the temporal position t′₁ and t′₃ of the leading edge. Further, the pulses output from the drivers 18₁ and 18₂ have a trailing edge, and the time measurement unit 19 is adapted to measure the pulse duration of the pulses output from the drivers 18₁ and 18₂ based on the temporal position t′₁ and t′₃ of the leading edge and the temporal position t′₂ and t′₄ of the trailing edge. In this embodiment, the pulses output from the drivers 18₁ and 18₂ have a leading rising edge and a trailing falling edge.

The processing unit 20 is adapted here, based on the measured propagation time of the pulses and/or the measured pulse duration, to control the pulse generator 17 to adjust the temporal positions t₁, t₂, t₃, and t₄ of the pulses so as to reduce the phase errors in generating the distance measurement image 21. As described above, in this way, signal propagation times of different length in the drivers 18₁ and 18₂ and/or changes in pulse durations can be compensated for by the drivers 18₁ and 18₂ immediately when the pulses are generated by the pulse generator 17. The pulses output from the drivers 18₁ and 18₂ then preferably have as correct a phase relationship as possible, so that the distance measurement is distorted only to a lesser extent or not at all by phase errors.

Alternatively, the processing unit 20 may also be adapted to perform a correction of the distance measurement values based on the measured propagation time of the pulses and/or the measured pulse duration when generating the distance measurement image 21, so as to reduce errors caused by the phase errors in the distance measurement image 21. For example, as described above, the full distance measurement image 21 can first be calculated based on the captured reflected light signals 16. Then, the measured delay time can be used to determine a distance correction value dₖ using the speed of light c, which corresponds to half the distance that the light signal travels during the delay time With the help of the distance correction value dₖ the distance measurement values can then be corrected in the distance measurement image 21, for example, by adding together the respective distance measurement value and the distance correction value dₖ.

In an exemplary embodiment, the correction can be made using the measured propagation time of the pulses without taking into account possible changes in the pulse duration. In this case, the distance correction value dₖ may be determined, for example, via the leading edge of the pulses output from the drivers 18₁ and 18₂ to be

$${d}_{k} = \frac{c}{2} ( ( {t}_{3}^{′} - {t}_{0} ) - ( ( {t}_{1}^{′} - {t}_{0} ) ) . \qquad ( 3 )$$

Alternatively, another exemplary way to determine the distance correction value dₖ is to determine the center of gravity or the position in time of the center of the pulses output from the drivers 18₁ and 18₂. A suitable formula for determining the distance correction value dₖ could be for example

$${d}_{k} = \frac{c}{2} ( ( \frac{1}{2} ( {t}_{3}^{′} + {{t}_{4}^{′}}^{} ) - {t}_{0} ) - ( \frac{1}{2} ( {t}_{1}^{′} + {t}_{2}^{′} ) - {t}_{0} ) ) . \qquad ( 4 )$$

The distance correction value dₖ determined according to equation (3) or (4) can then be added together with the respective distance measurement values of the distance measurement image 21 as described above.

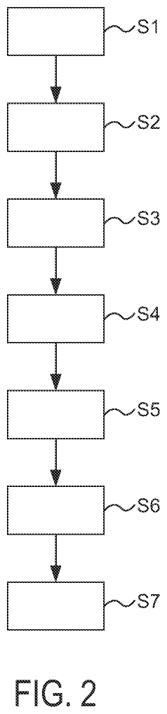

FIG. 2 shows schematically and exemplarily a flow chart of a ToF method according to the invention for measuring distance information for objects 14 of a scene. The ToF method can be performed, for example, with the ToF camera 10 shown in FIG. 1.

In step S1, light signals 15 modulated with a light source 11 are emitted for illuminating the objects 14.

In step S2, light signals 16 reflected from the objects 14 are captured with an image sensor 12.

In step S3, the exposure of the image sensor 12 is opened and closed with shutters 13.

In step S4, first pulses for switching the light source 11 and second pulses for switching the shutters 13 are generated with a pulse generator 17.

In step S5, the first pulses are amplified and output to the light source 11 with a first driver 181, and the second pulses are amplified and output to the shutters 13 with a second driver 182.

In step S6, the propagation time of the pulses through drivers 18₁ and 18₂ and/or the pulse duration of the pulses output from drivers 18₁ and 18₂ is measured with a time measurement unit 19.

In step S7, a distance measurement image 21 is generated based on the captured reflected light signals 16 with a processing unit 20, wherein the measured propagation time of the pulses and/or the measured pulse duration is used to generate the distance measurement image 21 with a reduced phase error.

It should be noted that the numbering of steps S1 to S7 of the above ToF method is not intended to establish a chronological order of the steps. For example, step S3, in which the exposure of the image sensor 12 is opened and closed with shutters 13, is carried out simultaneously with step S2, in which light signals 16 reflected from the objects 14 are captured with the image sensor 12.

In the representation of the ToF camera 10 according to the invention in FIG. 1, only a single pulse for switching the shutters 13 is shown—with the leading edge at the temporal position t₃ and the trailing edge at the temporal position t₄ or, after passing through the second driver 18₁, with the leading edge at the temporal position t′₃ and the trailing edge at the temporal position t′₄. In the described embodiment, in which three shutters (not shown individually in the Figure) are provided, three pulses (one for each shutter 13) with the same pulse duration are preferably generated per period of 360°, each of which is phase-shifted by 120°. These each have a leading edge at the temporal positions t₃, t₅, and t₇ and a trailing edge at the temporal positions t₄, t₆, and is (or after passing through the second driver 18₂ at the temporal positions t′₃, t′₅, and t′₇ and t′₄, t′₆, and t′₅ respectively). (The additional pulses for switching the shutters 13 with the leading edge at the temporal positions t₅ and t₇ (or after passing through the second driver 18₂ at the temporal positions t′₅ and t′₇) and the trailing edge at the temporal positions t₆ and t₈ (or after passing through the second driver 18₂ at the temporal positions t′₆ and t′₈) are not shown in the Figure.) The time measurement unit 19 is then advantageously adapted to measure for all pulses—i.e., the pulses for switching the light source 11 and the pulses for switching the three shutters 13—the propagation time of the pulses through the drivers 181 and 182 and/or the pulse duration of the pulses output from the drivers 181 and 182.

It should be explicitly pointed out here that an electronic shutter or shutter can also be realized by a suitable modulation of the image sensor. In image sensors with a CAPD (current assisted photonic demodulator) pixel structure, for example, an AC voltage is applied inside each pixel electrode, which generates drift fields that separate the electrons generated by a photodetector and pulls them to alternating detector junctions. A further example are detectors that use a so-called QEM (quantum efficiency modulation) technology, where the quantum efficiency of the photodetector is varied to obtain distance information for objects in a scene.

In the claims, the words “including” and “comprising” do not exclude other elements or steps, and the indefinite article “a” does not exclude a plurality.

A single unit or device may perform the functions of a plurality of elements recited in the claims. For example, the pulse generator 17 may be configured to store the temporal positions t1, t2, t3, and t4 of the pulses generated by the pulse generator 17 relative to the temporal position t0 of the start pulse. In this case, therefore, the storage unit 22 is implemented by the pulse generator 22.

The fact that individual functions and/or elements are listed in different dependent claims does not mean that a combination of these functions and/or elements could not also be used advantageously.

The reference signs in the claims are not to be understood in such a way that the subject matter and the scope of protection of the claims are limited by these reference signs.

In summary, a time-of-flight, ToF, camera for measuring distance information for objects in a scene has been described. The ToF camera comprises a light source for emitting modulated light signals for illuminating the objects, an image sensor for capturing light signals reflected from the objects, shutters for opening and closing the exposure of the image sensor, a pulse generator for generating first pulses for switching the light source and second pulses for switching the shutters, a first driver for amplifying the first pulses and outputting them to the light source, and a second driver for amplifying the second pulses and outputting them to the shutters, a time measurement unit for measuring the propagation time of the pulses through the drivers and/or the pulse duration of the pulses output from the drivers, and a processing unit for generating a distance measurement image based on the captured reflected light signals, wherein the processing unit is adapted to use the measured propagation time of the pulses and/or the measured pulse duration to reduce the influence of phase errors on the distance measurement image.

1.-11. (canceled)

12. A time-of-flight (“ToF”) camera for measuring distance information for objects of a scene, the ToF camera comprising:
a light source for emitting modulated light signals for illuminating the objects;
an image sensor for capturing light signals reflected from the objects;
one or more shutters for opening and closing the exposure of the image sensor;
a pulse generator for generating first pulses for switching the light source and second pulses for switching the one or more shutters;
a first driver for amplifying the first pulses and for outputting them to the light source, and a second driver for amplifying the second pulses and for outputting them to the one or more shutters;
a time measuring unit for measuring the propagation time of the pulses through the drivers or the pulse duration of the pulses output from the drivers; and
a processing unit for generating a distance measurement image based on the captured reflected light signals, wherein the processing unit is adapted to use the measured propagation time of the pulses or the measured pulse duration to reduce the influence of phase errors on the distance measurement image.

13. The ToF camera according to claim 12, wherein the time measurement unit is a time-to-digital converter.

14. The ToF camera according to claim 12, wherein the pulse generator is adapted to generate and output a start pulse to the time measurement unit, and wherein the time measurement unit is adapted to start the measurement of the propagation time of the pulses through the drivers or of the pulse duration of the pulses output from the drivers upon receipt of the start pulse.

15. The ToF camera according to claim 14, further comprising a memory unit for storing the temporal positions of the pulses generated by the pulse generator relative to the temporal position of the start pulse.

16. The ToF camera according to claim 12, wherein the time measurement unit is adapted to receive the pulses output from the drivers and to measure the propagation time of the pulses through the drivers or the pulse duration of the pulses output from the drivers based on the received pulses.

17. The ToF camera according to claim 16, wherein the pulses output from the drivers have a leading edge and the time measurement unit is adapted to measure the propagation time of the pulses through the drivers based on the temporal position of the leading edge.

18. The ToF camera according to claim 17, wherein the pulses output from the drivers further comprise a trailing edge and the time measurement unit is adapted to measure the pulse duration of the pulses output from the drivers based on the temporal position of the leading edge and the temporal position of the trailing edge.

19. The ToF camera according to claim 12, wherein the pulses output from the drivers have a leading rising edge and a trailing falling edge.

20. The ToF camera according to claim 12, wherein the processing unit is adapted, based on the measured propagation time of the pulses or the measured pulse duration, to control the pulse generator to adjust the temporal positions of the pulses so as to reduce the phase errors in generating the distance measurement image.

21. The ToF camera according to claim 12, wherein the processing unit is adapted to perform a correction of the distance measurement values based on the measured propagation time of the pulses or the measured pulse duration when generating the distance measurement image, so as to reduce errors caused by the phase errors in the distance measurement image.

22. A time-of-flight, ToF, method for measuring distance information for objects of a scene, the ToF method comprising:
emitting modulated light signals for illuminating the objects, with a light source;
capturing light signals reflected from the objects, with an image sensor;
opening and closing the exposure of the image sensor, with one or more shutters;
generating first pulses for switching the light source and second pulses for switching the one or more shutters, with a pulse generator;
amplifying the first pulses and outputting them to the light source, with a first driver, and amplifying the second pulses and outputting them to the one or more shutters, with a second driver;
measuring the propagation time of the pulses through the drivers or the pulse duration of the pulses output from the drivers, with a time measurement unit; and
generating a distance measurement image based on the captured reflected light signals, wherein the measured propagation time of the pulses or the measured pulse duration is used to reduce the influence of phase errors on the distance measurement image, with a processing unit.
